(19) United States
(12) Patent Application Publication
(10) Pub. No.: US 2017/0056783 A1
(43) Pub. Date: Mar. 2, 2017

(54) System for Obtaining Authentic Reflection of a Real-Time Playing Scene of a Connected Toy Device and Method of Use

(71) Applicant: Seebo Interactive, Ltd., Tel Aviv (IL)

(72) Inventors: Lior Akavia, Tel Aviv (IL); Liran Akavia, Tel Aviv (IL); Yarden Hod, Tel Aviv (IL); Mordechi Moti Lavian, Tel Aviv (IL)

(73) Assignee: Seebo Interactive, Ltd., Tel Aviv (IL)

(21) Appl. No.: 15/119,332

(22) PCT Filed: Feb. 18, 2015
(86) PCT No.: PCT/IL2015/050191

§ 371 Date: Aug. 16, 2016

Related U.S. Application Data
(60) Provisional application No. 61/941,075, filed on Feb. 18, 2014.

(51) Int. Cl. A63H 33/26; G06K 9/00; A63H 33/00; A63H 3/00; A63H 33/30; H04N 7/18; G06F 3/01

(52) U.S. Cl. CPC A63H 33/26; H04N 7/185; G06K 9/00664; G06F 3/017; A63H 3/003; A63H 33/3055; A63H 33/009; A63H 2200/00

(57) ABSTRACT

The invention is directed to a connected toy device comprising at least one sensing element configured to provide a complementary data to a limited visual recognition data obtained from a camera, so as to obtain an accurate reflection of a real-time playing scene of a player with said connected toy device and allow production of a suitable response to the player on a smart device connected to said toy according to processing of the combined data obtained from said camera and the at least one sensing element. The invention is further directed to a connected toy system for obtaining an accurate reflection of a real-time playing scene of a player with a connected toy device, the system comprising: at least one connected toy devise having at least one sensing element configured to provide a complementary data to a limited visual recognition data obtained from a camera; and a smart device having at least a camera, a processing device and a dedicated software library, said smart device is configured to capture images of said playing scene by said camera process the data and combine the image data with data received from said at least one sensing element, and produce a suitable response on the smart device according to the data obtained from the camera and the sensing element reflecting a real time occurrence at the playing scene.

### FIELD OF THE INVENTION

This invention is in the field of connected toys in general, and more particular it is directed to a method and system for obtaining a reliable reflection of the reality relative to the usage of the connected toy by combining camera and sensors as indicative means.

### BACKGROUND

Physical toys containing electronic components are, traditionally named ‘Electronic toys’ and are commonly seen in the average household of the 21st century. In the last few years, a new trend seems to be emerging, of connecting these electronic toys to software applications and/or to the internet. This trend generally named the “Internet of things” and describes the general tendency to connect various consumer products to the internet and to smart devices of the user (for more details: http://en.wikipedia.org/wiki/Internet_of_Things).

In the past several years, there have been many developments in the field of connected toys, and many connected toys are available in the markets. International Patent Application WO/2013/024470 of the same inventors incorporated herein by reference, discloses a connected multifunctional toy system for providing a user a learning experience, entertaining experience, and a social experience. The connection of toys to software programs, to websites and/or servers make them “smarter” and dynamic. Another example of a connected toy is the Furby toy from Hasbro™ that connects to the web indirectly (http://www.hasbro.com/furby/en_US/#panel_talk). This toy can connect to tablets and smartphones through encoded sound frequencies. The connection allows the user to feed his Furby toy with different dishes, record a video of them playing together and the like. Another example of such a toy is disclosed in http://www.skylanders.com that discloses the use RFID technology to identify characters and show them on the screen with a matching video as described in details in US Patent Application No. 20120295703. The RFID allows the game to identify the character placed on the toy-stage, and to identify different objects placed on the same spot, but not to identify a location or relativity (e.g. one character stands on the right side of another character). Another similar example is described in http://www.youtube.com/watch?v=DqyaIyUukQg that discloses another attempt to create a combined experience of virtual game and a physical toy. In this specific example, the toy needs to be placed on a tablet camera, which identifies certain characteristics of the toy to identify it. Here, there is no information about location and orientation as well. Another example is the Apptivity Barn from Fisher Price™ (http://www.youtube.com/watch?v=wZalFItbsMs), which allows recognition of toy elements in many locations upon the iPad itself, but the identification is totally dependent on a tablet screen, and therefore barn cannot be connected to many other devices, such as PC, smart TV and different sizes of tablets and smartphones. In addition, using the tablet as an identification surface is less protective for the tablet, and the presented virtual content might be limited (since the figures must be placed on the screen and they usually block the vision).

Usage of a camera for recognition of movement and identification of objects is well known in the art. This technology is based on capturing a live stream of frames with visual content, and analyzing the data to recognize predefined patterns, shapes and colors (e.g. objects, faces, surfaces, etc.), and to extract visual features (e.g. objects motion, gestures, changes in time, etc.). New developments allowed for this technology to appear useful in the field of virtual games, such as the case of the Kinect™ console by Microsoft: http://en.wikipedia.org/wiki/Kinect In this example, the user stands in front of a TV, and a special motion sensing input device, which includes a camera and Based around a webcam-style add-on peripheral, it enables users to control and interact with their console/computer without the need for a game controller, through a natural user interface using gestures and spoken commands. However, this technology is limited by its constellation: since it depends mainly on the camera, most of the identification is based on the visual input in a specific range and field of vision, and this fact of course has its own limitations.

The following references may be considered as relevant to the subject matter disclosed herein: US2012052934, U.S. Pat. No. 8,696,458, US2008285805, U.S. Pat. No. 8,602,857, and US2012233076.

The present invention provides wireless data transfer solution with/to objects; it introduces various solutions to current limitations of cameras. With the integration of other sensors (input/output), the overall system performance is improved. By using and combining the data and capabilities of the additional sensors to those of a camera, it becomes possible to overcome the original limitations of the camera and enable new features or improve the quality of existing ones.

### SUMMARY OF THE INVENTION

The subject matter disclosed herein is directed to a connected toy device comprising at least one sensing element configured to provide a complementary data to a limited visual recognition data obtained from a camera, so as to obtain an accurate reflection of a real-time playing scene of a player with said connected toy device and allow production of a suitable response to the player on a smart device connected to said toy according to processing of the combined data obtained from said camera and the at least one sensing element. The sensing element may be configured to provide a complementary data about the real-time playing scene for hidden objects and/or actions made by the player that are not captured by said camera upon usage of said toy device. The sensing element may further provide a complementary data about the real-time playing scene for objects that are positioned outside the field of vision of said camera upon usage of said toy device. Additionally or alternatively, the sensing element may be configured to provide a complementary data about the real-time playing scene for at least one movable object that its distance from said camera changes upon usage of said toy device. Additionally or alternatively, the sensing element may be configured to provide a complementary data about the real-time playing scene for at least two identical objects that are being played with simultaneously so as to allow the camera ability to distinguish between them. In a further implementation of the invention, the sensing element may be configured to provide a complementary data about the real-time playing scene when the player apply force and/or touch the connected toy device and parts thereof.

The sensing element may be by way of none limiting example: RFID, NFC, capacitive sensors, hotspots, ultrasonic triangulation based sensors, sensors based on energy harvesting, weight sensors, photo-sensors, color sensors, gated buttons, and a camera. In addition to the sensing element, the connected toy device may further comprise input and/or output elements.

The visual recognition data is preferably but not necessarily obtained from a camera of a smart device, wherein the complementary data obtained by the sensing element is transmitted and analyzed by said smart device to thereby allow processing of the combined data.

The connected toy device may further comprise an output element, wherein said output element is activated by data obtained from the camera in response to environmental conditions in the real-time playing scene. The output element in such scenario may be a light being turned on/off according to inadequate lighting condition that limits accurate image recognition of the real-time playing scene by said camera.

In some embodiments of the invention, the sensing element is an identification sensor configured to provide a complementary data for identifying the relations between objects in space of the playing scene in real-time.

The invention is further directed to a connected toy system comprising a connected toy device according to the aforesaid and a smart device having a dedicated software library configured to allow processing of image data obtained by a camera of said smart device together with data received from said toy device, and producing a suitable response on the smart device reflecting a real time occurrence at the playing scene. Additionally or alternatively, the suitable response may be produced on the connected toy device.

The invention is further directed to a connected toy system for obtaining an accurate reflection of a real-time playing scene of a player with a connected toy device, said system comprising: (a) at least one connected toy devise having at least one sensing element configured to provide a complementary data to a limited visual recognition data obtained from a camera; and (b) a smart device having at least a camera, a processing device and a dedicated software library, said smart device is configured to capture images of said playing scene by said camera process the data and combine the image data with data received from said at least one sensing element, and produce a suitable response to said player according to the combined data obtained from said camera and said at least one sensing element reflecting a real time occurrence at the playing scene.

The invention is further directed to a connected toy system for obtaining an accurate reflection of a real-time playing scene of a player with a connected toy device, said system comprising: at least one connected toy devise having at least one sensing element configured to provide a complementary data to a limited visual recognition data obtained from a camera; and a smart device having at least a camera, a processing device and a dedicated software library, said smart device is configured to capture images of said playing scene by said camera process the data and combine the image data with data received from said at least one sensing element, and produce a suitable response to said player according to the combined data obtained from said camera and said at least one sensing element reflecting a real time occurrence at the playing scene. The camera may be a camera of a smart device or it may be an independent camera configured to submit the image data captured at the playing scene to the smart device.

The invention is also directed to a method for obtaining an accurate reflection of a real-time playing scene of a player with a connected toy device, with the connected toy device described above. The method comprising the following steps:
a. Obtaining data from at least one connected toy devise having at least one sensing element configured to provide a complementary data to a limited visual recognition data obtained from a camera and transmitting the obtained data to a smart device;
b. Obtaining data from a camera configured to capture images in real-time of said playing scene and transmitting the data to said smart device;
c. Processing the data obtained from said camera and said connected toy device by the smart device said, smart device having a dedicated software library, configured to combine the image data with data received from said at least one sensing element of the toy; and
d. Producing a suitable response according to the combined data obtained from said camera and said at least one sensing element reflecting a real time occurrence at the playing scene.

### BRIEF DESCRIPTION OF THE FIGURES

Examples illustrative of variations of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. The figures presented are in the form of schematic illustrations and, as such, certain elements may be drawn greatly simplified or not-to-scale, for illustrative clarity. The figures are not intended to be production drawings.

The figures (Figs.) are listed below.

FIG. 1A is a schematic illustration of optional setup of objects and a camera demonstrating the limitation of the camera as to the field of vision for reflecting an authentic image of the reality and the solution proposed for overcoming this limitation;

FIG. 1B is a schematic illustration of a gun toy with a trigger button implementing the solution illustrated in FIG. 1A;

FIG. 2 is a schematic illustration of optional setup of objects and a camera demonstrating the limitation of the camera as to estimation of distance of objects for reflecting an authentic image of the reality and the solution proposed for overcoming this limitation;

FIG. 3 is a schematic illustration of optional setup of objects and a camera demonstrating the limitation of the camera as of tracking physical contact between two or more objects and the pressure performed on the object for reflecting an authentic image of the reality and the proposed solution for overcoming this limitation;

FIGS. 4A-4C illustrate a child and a hugging in various positions illustrating the additive value obtained by the combination of sensing elements with visual data to obtain a reliable presentation of the reality in a play scene and avoid false positive reading.

FIGS. 5A-5D are schematic illustration of a connected stove toy with identifiable playing items comprising RFID sensors in different positions and the additive value obtained by the combination of RFID sensors with visual data obtained from a camera in obtaining a reliable presentation of the reality in a play scene and avoid false positive reading.

FIG. 6 is a state flow chart illustrating the states of a player feeding a connected baby doll with a bottle, wherein identification of the play scene is obtained by combination of data from a camera, a pressure sensor and proximity sensor.

FIG. 7 is a schematic illustration of optional setup of objects and a camera demonstrating the limitation of the camera as to differentiation between two or more identical objects for reflecting an authentic image of the reality and the proposed solution for overcoming this limitation.

### DETAILED DESCRIPTION OF EMBODIMENTS OF THE INVENTION

The present invention is directed to a system, a method and a device for reflecting authentic and reliable reflection of the reality at a playing scene in connected toys systems that involve image recognition and make use of information coming from a camera, whether it is implemented inside a smart device (such as, but not limited to, the implemented camera in smartphone, tablets, phablet, and smart TV), or whether it is an external camera placed in the playing area that transmits the image data to a smart device or a separated processing device, (for example, a camera placed above a TV or PC), and integrating the information from the camera with an information coming from sensors implemented in the physical toy. The integration of such information, improves the information coming solely from each one of these technological solutions, and adds accuracy of information about the situation occurred in the reality at a specific time frame, and as such, it improves the playing experience and allows a better output responses to the player.

The term ‘connected toy device’ as used herein refers to a toy having ability to connect with smart devices, namely, electrical toys having the ability to connect with computerized electronic devices that have the ability to receive and transmit data from the to the toy, either by a wired connection or by wireless communication methods known in the art (such as but not limited to Bluetooth, BLE, and Wi-Fi). The smart device comprises a dedicated software application (app) installed on it that allows the communication with the toy connected thereto and the processing of data.

The computation of the toy's visual characteristics from the information coming from the camera may depend on many different visual features, such as colors, position in space and 3D information (in case of a 3D camera). All these characteristics may be computed into algorithms, which may identify the toy, react to the toy's location, movements, rotation, and the like. Nonetheless, these algorithms are limited in the sense that they depend only on visual information coming from the camera. For example, the camera will have difficulties with actions briefly hidden behind the player's hand, gentle gestures or movement or rotation, which are more complicated to compute through visual imaging.

Hardware component placed inside the physical toy may complete the information, which can be integrated with the camera algorithms in order to create a more accurate reflection of the reality and provide the player enhanced playing experience close as possible to the “real world”. The Hardware inside the toy may include various sensors as well as Input and Output elements (I/O), including by way of example, identification components such as resistors, RFID, NFC, capacitive sensors, ultrasonic triangulation and photo sensors, LEDs, potentiometers, piezoelectric sensors, touch sensors, light sensor, color sensors, accelerometer, buzzer, speaker, and microphone. Each of these components may complete the computation made by the camera in a different manner, reducing one of the common errors made by the camera and adding additional fun features, thus creating a better game experience and reducing false detection rate.

The present invention is directed to a device, a system and a method that allow to obtain an accurate indication of a real time playing scene of a player with a connected toy device, by way of comprising within the connected toy device at least one sensing element configured to provide a complementary data to a limited visual recognition data obtained from a camera. The visual input may provide enough information in order to identify proximity between two objects or more, and thus deduct a touch, but this solution has a significant false positive rate, since it is influenced by the angle and 3D relations between the objects, which may be misleading. The present invention is aimed to provide solution to problematic occurrences and to allow for example, distinguishing between a hug of the toy performed by the player, versus a smash of the toy, intentional pressure on a toy versus accidental smashing of the toy. The method provided herein may further allow recognition and correction of error situations such as false recognition of a Hall Effect sensor that recognizes a different magnetic field than the magnetic field of an object and a false positive indication is provided.

The camera may be an independent camera configured to submit the image data captured at the playing scene to a smart device.

The present invention in a further aspect is directed to a method for obtaining an accurate reflection of a real-time playing scene of a player with a connected toy device, said method comprising the following steps: (a) Obtaining data from at least one connected toy devise having at least one sensing element configured to provide a complementary data to a limited visual recognition data obtained from a camera and transmitting the obtained data to a smart device; (b) Obtaining data from a camera configured to capture images in real-time of said playing scene and transmitting the data to said smart device; (c) Processing the data obtained from said camera and said connected toy device by the smart device said, smart device having a dedicated software library, configured to combine the image data with data received from said at least one sensing element of the toy and to process the data; and (d) Producing a suitable response according to the processed data, said response is reflecting a real time occurrence at the playing scene.

In accordance with the subject matter provided herein, the processing device may be an independent device or a processing module of the smart device. In any variation the processing device is characterized by having communication capability, processing capability and it is programmable. The processing device is configured to be operated with a dedicated software library that receives the data from the camera and from the various sensing elements implemented in the connected toy/s, and enable integration of the gathered data and to allow producing of a relevant output to the player according to the processed data. In the following, some examples for camera limitations and proposed solutions are described below with reference to the figures:

A. Field of Vision

One major limitation of cameras is that cameras cannot capture objects if they are out of the visible frame or if they are hidden by other objects. This limitation may be crucial when a reliable reflection of the reality is required for providing relevant and accurate outputs for a player and displaying the connected toy or the action performed on it in real time. This limitation may occur for example, in a kitchen toy when the camera is positioned above a toy stove and below the stove an oven is positioned out of the camera's line of site. Any action performed by the player on the oven will not be captured by the camera.

This limitation may be bypassed by the addition of sensor/s that are not dependent on field of vision with the image recognition of the camera, in a manner that the system will obtain data from the camera in its visual field of the surroundings and combine data triggered by the additional sensor/s.

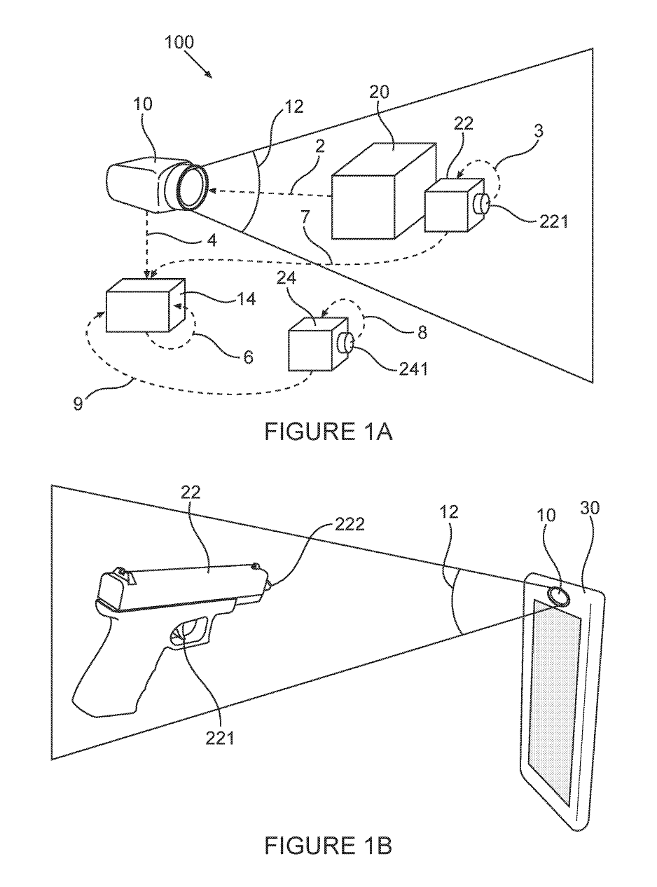

FIG. 1A is a schematic illustration of optional setup 100 of connected toys 22 and 24, other object at the playing area 20, and a camera 10 demonstrating the limitation of the camera for reflecting accurate image of a real-time playing scene outside its field of vision 12. In the specific example illustrated in this figure, a button 221 is attached to a hidden toy 22, so as to provide data upon its operation and compensate for the camera limitation. It should be clear that other sensing elements instead of a button may also be used and are within the scope of the invention. As shown in the figure, object 20 hides connected toy 22 and consequently, connected toy 22 is hidden and not being captured by camera 10 although it is within the camera field of vision 12. The capture image 2 at this positioning is of object 20 only and the image data 4 is transmitted to processing device 14. Camera 10 is preferably but not necessarily a smart device's camera and connected to processing device 14 of said smart device that allows analysis of the visual data obtained from the camera and further allows the analysis of the data obtained from the connected toy in order to produce a relevant output according to the processed data. To overcome this limitation, button 221 is attached to connected toy 22. When button 221 is triggered the data 3 is received in the connected toy 22, and the event and/or data 7 are transmitted to the smart device (e.g. to processing device 14). The data is processed together with the data obtained from the camera, so as to obtain more accurate reading of the real-time events at the play scene and to allow the smart device to output and/or display 6 a correct response and/or image of the playing scene.

A similar situation may occur for a connected toy 24 that is positioned out of the camera frame. In this scenario, connected toy 24 is not captured by the camera 10, since it is out of the camera field of vision 12. One optional solution for detecting the out of frame connected toy is by attaching a functional button 241 to it. Upon activation of toy 24, button 241 is triggered and the data 8 is sent to toy 24 that further transmits the occurrence of the event and/or the data 9 to the processing device 14 of the smart device. In some embodiments of the invention object 20 and 22 may be two parts of the same object that in some orientation one part conceals the other part from the camera's line of vision due to structural design of the connected toy.

FIG. 1B is a schematic illustration of optional implementation of utilizing a button in a connected toy for overcoming the limitation of the camera to capture an action or an event in a hidden position or outside the camera's field of vision. In the specific example illustrated herein, connected toy gun 22 comprises a button 221 in a shape of a trigger, said button is configure to provide complementary data upon pressing of the player on the button that is positioned out of the camera 10 field of vision 12, as its position is usually concealed from the camera by the player's finger during the expected use of the connected toy gun. The additional data received from the button allows a correct display of the reality on the smart device 30 screen and/or another relevant response performed by the smart device 30 (such as orders to the players, complement to the player, change of color on the screen, production of sounds by the smart device) that are relevant to the shooting performed by the player in a specific time frame. In an optional embodiment, upon pressing on the trigger of the connected gun, a LED 222 may be turned on or blink to further indicate to the camera that “shooting” occurred.

B. Distance from Camera

Camera recognition algorithms cannot deduce the distance of visible objects without specific calibration. Moreover, distance comparison between two different or identical objects is not reliable enough and with high tolerance. This limitation may result in none accurate reflection of a real-time playing scene of a player with a connected toy device and further to result in the production of a none-suitable response to the player, and/or a none-accurate display of real scene on the smart device.

It is possible to overcome this limitation of the camera by using wireless radio transmitting methods, such as Bluetooth or Bluetooth Low Energy (BLE) that allows the reading of Received Signal Strength Indication (RSSI) value. This value can be used to estimate the distance of the transmitting object to a central unit. This value can also be used to compare distance of multiple objects, as the RSSI value is opposite in trend with the distance of the source of the signal (the farther the object, the lower the RSSI value). The usage of RSSI and distance estimation, with the combination of the normal camera recognition, is therefore improved as it allows outputs position in three dimensions. This example can be further understood by thinking on the three dimension (3D) playing scene, in which numbers of objects are located in different distances from the camera at the playing scene. A camera, located in a specific spot in space may contribute an accurate information about the object location on axis X (left or right) and axis Y (up or down), but may need more information in order to determine the object's location on axis Z (near or far). In some embodiments, the camera may use a few visual clues in order to get additional information on the location of the object on axis Z, for example, if there are two or more objects in the space, the camera may determine that the bigger object is the closest. In a playing scene that lacks these visual references, the camera may need a complementary data from the hardware implemented in the object. The proposed solution complements the two dimension (2D) information coming from the camera, into a full 3D overview of the playing scene, thus it improves the reflection of the playing scene in real time and allow more correct presentation of the reality. The technological solution may be the use of RSSI, or other distance sensors known and available in the art.

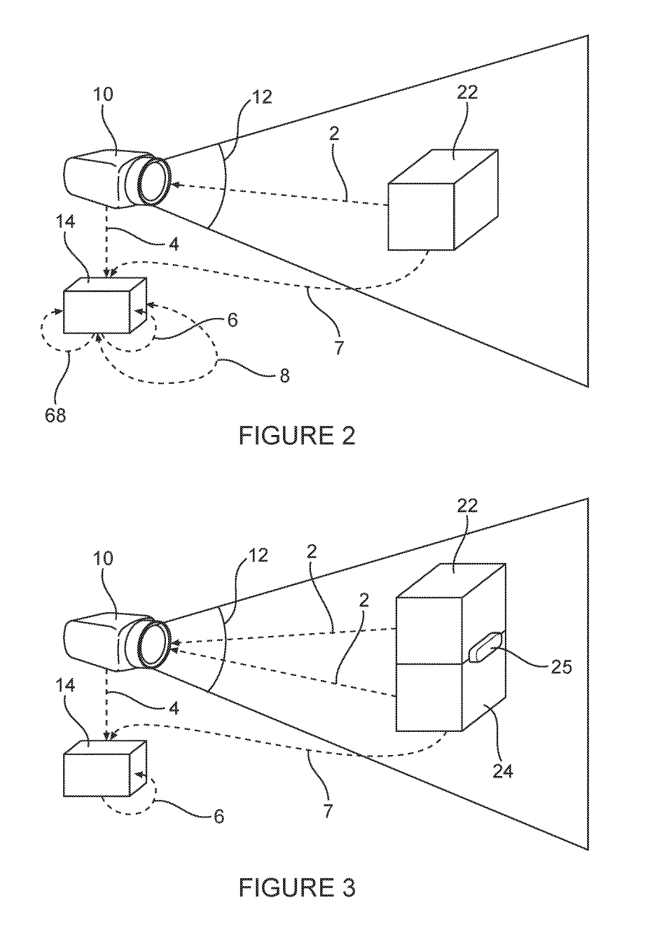

FIG. 2 is a schematic demonstration of the combination of RSSI with a camera analysis in accordance with examples of the present invention. Camera 10 captures an image 2 of connected toy 22 positioned within the field of vision 12 of camera 10 and transmits the image data 4 to a processing device 14, preferably but not necessarily implemented in a smart device that processes the data 6 and allows the production of a suitable response. The connected toy 22 in this example may be a vehicle including by way of example a car, an airplane, a boat and the like. Connected toy 22 comprises transmitting means that allows transmission of RSSI value 7. The RSSI value is processed 8 by processing device 14 and distance estimation is achieved. In a scenario that the play scene comprises more than one connected toy each of them transmitting different RSSI value, and the processing device 14 may further compare between distances of the different connected toys and provide a respective output according to the data obtained (yellow car wins in a race with blue and red cars). By combined data 68 obtained by the image recognition and the RSSI value a three dimensional positioning of objects in the playing scene is obtained.

C. Relations Between Objects in Space

Camera and image recognition are limited with tracking physical contact between two or more objects. When two objects are positioned one behind the other, their contours blend together, making it harder for the recognition to differentiate between them. Moreover, if the application of the smart device should recognize a contact between the two objects, it may receive a false detection, due to the fact that from the camera's point of view, the two objects are viewed as if they are touching one another. Furthermore, even if contact detection is achieved, the extent of it (i.e. pressure extent) cannot be deducted from the image recognition process.

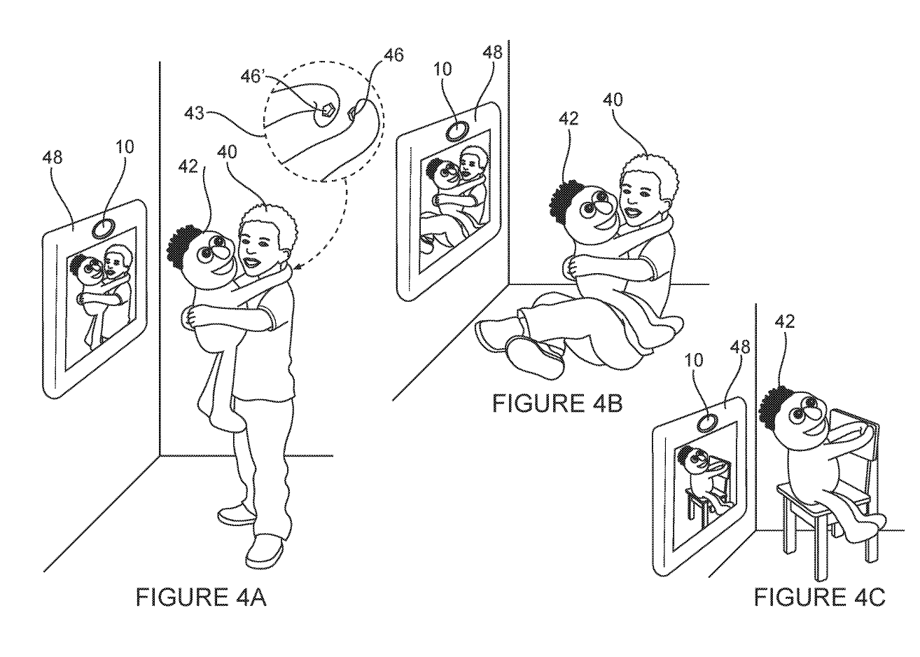

To overcome this limitation a piezometer or other pressure sensor may be added to the connected toy. By adding pressure sensors and/or piezoelectric sensor, the smart device may use the input of whether two objects physically touch each other. Further, the reading of a pressure level may add information and indicate about how strong they are pushed against each other. The concept of using such sensors in addition to visual data obtained by a camera is illustrated in FIG. 3. Camera 10 captures images 2 of connected toys 22 and 24 positioned within the field of vision 12 of camera 10 and transmits the images data 4 to processing device 14 that processes the data 6. A pressure sensor 25 positioned in the contact area of the two toys is configured to detect a physical contact between the toys and its strength. The data 7 from the sensor is transmitted to the processing device 14 that add the information to the image data obtained from the camera, so as to capture a reliable image of the play scene and produce the at most relevant response to the identified reality.

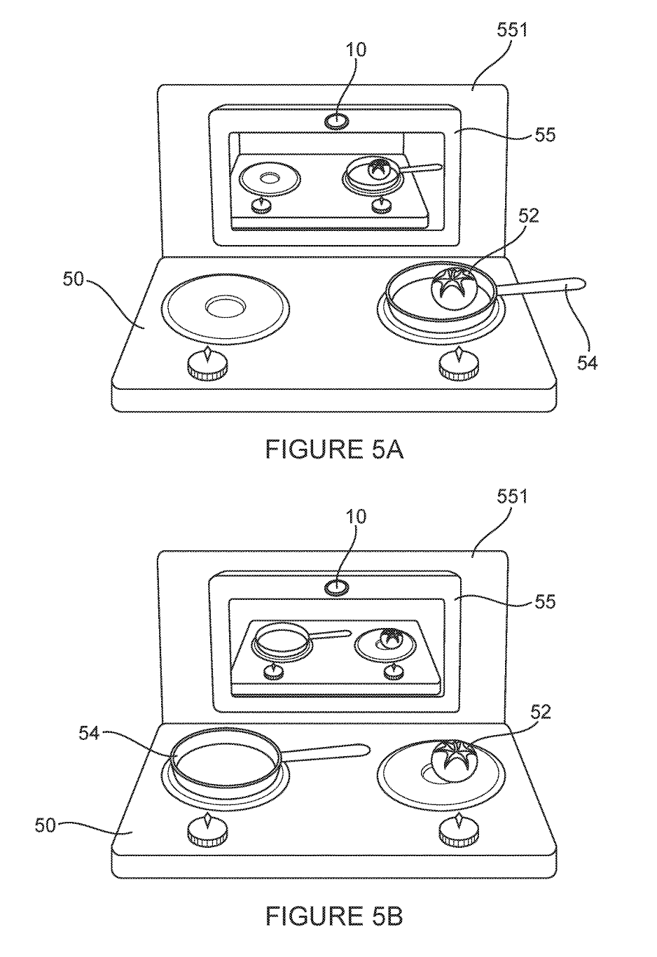

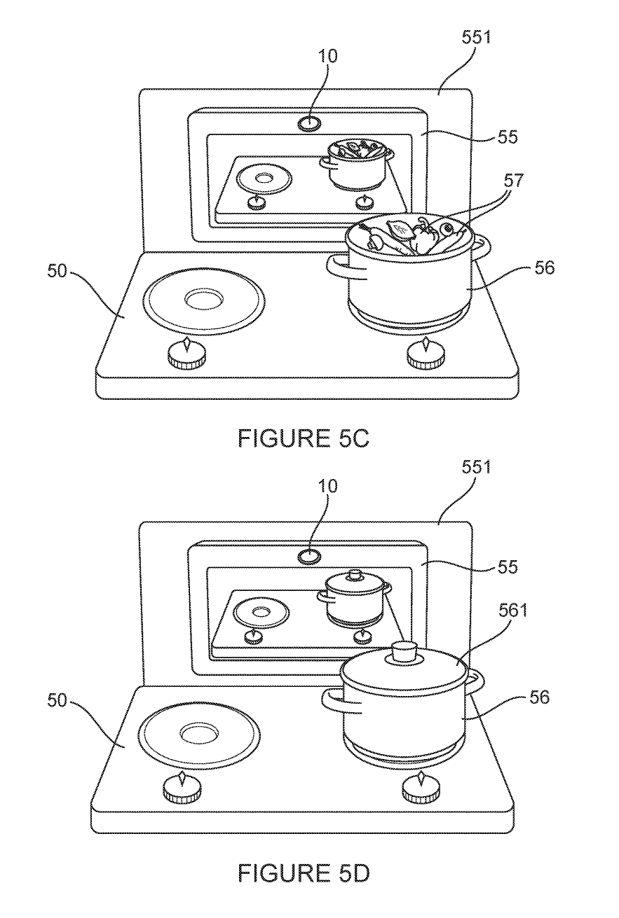

The importance of combining data obtain from sensors embedded in the connected toy device and integrate the data obtained with the image data obtained from the camera can be crucial in the ability of the smart device to obtain an accurate reflection of a real-time playing scene of the player with the connected toy device, and further in its ability to produce a suitable response to the player and/or display a relevant image according to the accuracy of the playing scene recorded by the processing device according to the data obtained from the camera and the sensing element. The additive value of the complementary relations between the camera and the sensors will further be understood from the examples illustrated in FIGS. 4 and 5.

FIGS. 4A and 4B illustrate a child 40 hugging a doll 42 in a standing and sitting positions respectively. FIG. 4C illustrates doll 42, wherein the hands of the doll are attached. In this specific example, a hug is identified by a Hall Effect sensor 46 with a magnet 46′ that are placed in the doll's hands as illustrated in bubble 43, in a manner that upon attachment of the doll's hands one to the other the sensor provides indication that is recognized by the smart device 48 as a hug. In addition, a hug may be recognized by the camera 10 of the smart device as long as the doll and the child are seen in the captured image when the hands of the doll are combined together around the child's neck and the combined hands of doll 42 are in the line of sight of the camera 10. If the back side or the profile of the child or the doll is not captured by the camera 10, no identification of a hug will be obtained.

In the specific example illustrated herein, the camera can identify when the child is in a standing position or in a sitting position and provide the player different outputs according to his situation, although the sensor provides the same indication in both scenario. For example, when the child and the doll are recognized as standing and hugged the output may be a song and a command to dance together. When the child and the doll are recognized as sitting and hugged the output may be to roll together on the floor for three times. However if the child holds the doll and the doll's hands are not attached to each other behind the child's back, though camera 10 may consider the situation as a hug, the hall effect sensor 46 will not sense magnet 46′, and thus will correct the false positive detection of the camera by transmitting to the smart device 48 that a hug did not occur. Smart device 48 will recognize this situation and the dedicated app installed on the smart device may instruct the child to connect the doll's hands around his neck for a hug. FIG. 4C illustrates the limitation of the sensor in a manner that upon attachment of the hands of the doll without hugging the child a positive read of the sensor will be obtained in the smart device that may result in a wrong reading of the playing scene and producing irrelevant output such as a display of a child hugging the doll on the smart device's screen. In such scenario, the camera 10 should provide additive information as the image data do not recognize a child in the frame, and therefore the output produced by the smart device 48 should be different, for example, producing a voice message that encouraging the child to pick up the doll and put its hands together around his neck. Thus, the combination of the camera's input and the sensor's input together may provide more accurate reflection of the connected toy state in a specific time point and contribute to a smarter playing experience to the player.

The following code proposes an example of a procedure for combining camera input for recognizing objects with RFID proximity, as of recognizing that one object (tomato) is positioned inside a second object (pan) and recognizing that they are both placed on top of a third object (stovetop).

Let be:

| | |
|---|---|
| • | C - camera with image recognition capabilities. |
| • | S - target connected object, for example a stovetop, and; |
| • | R - RFID reader mounted on top of S, and; |
| • | T - accessory object to be recognized near S, for example a |
| | tomato, and; |
| • | P - another accessory object to be recognized near S, for example |
| | a pan, and; |
| • | L_{O} - recognized location of some object O by camera C, and; |
| • | L_{O,Q} - recognized relative location between some objects O and Q. |

Provided that:

| • | C captures S, T, P in real time and recognizes their location | | | | |
|---|---|---|---|---|---|
| | independently, and; | | | | |
| • | R recognizes proximity between S, T, P, and; | | | | |
| • | T, P, S, can be placed near and in any position relative to each | | | | |
| | other (ABOVE, BELOW, RIGHT, LEFT, etc.) independently, and; | | | | |
| • | T can be placed inside P. | | | | |
| 1. | Scan and connect to target object S. | | | | |
| 2. | Capture and recognize image via camera C. | | | | |
| 3. | Scan and recognize proximity with RFID reader R. | | | | |
| 4. | On RFID reader R reading proximity of accessory objects T AND | | | | |
| | P, AND If P is recognizable by the camera C, do: | | | | |
| | 4.1. | Read L_{P} (recognized location of P by camera C) and L_{S} | | | |
| | | (recognized location of S by camera C). | | | |
| | 4.2. | Calculate L_{P,S} (relative location between P and S): | | | |
| | | 4.2.1. | If ABOVE, then: | | |
| | | | 4.2.1.1. | If T is NOT recognizable by camera C, | |
| | | | | then: | |
| | | | | 4.2.1.1.1. | OUTPUT T is inside P and |
| | | | | | on top of S. |
| | | | 4.2.1.2. | Else: | |
| | | | | 4.2.1.2.1. | OUTPUT T is outside P, and |
| | | | | | on top of S. |

| 4.2.2. | Else: | |
|---|---|---|
| | 4.2.2.1. | Discard, no significant interesting finding. |

FIGS. 5A to 5D are schematic illustrations of additional playing scenes that require the combined of data obtained from sensors attached to or embedded in a connected toy device with the data obtained from a camera of a smart device connected with the toy device, in order to obtain a true reflection of the reality in the play scene at a specific moment and further to produce or display a relevant response to the data to the reflected scene. FIGS. 5A and 5B illustrate a connected toy stove 50 having an RFID reader and antenna implemented within it (not shown) that allows recognition of various playing items each having a unique RFID tag, such as a tomato 52 and a pan 54 positioned and a stand 551 for positioning a smart device 55 in apposition that the camera 10 of the smart device 55 captures the play scene. Upon positioning of the tomato and the pan on the stove, the RFID sensors identifies that a tomato and a pan are now positioned on the stove and this data is transmitted to the smart device connected to the toy. However, the RFID sensor cannot identify the relations between the objects, i.e. the exact location of the tomato relative to the pan and the stove. Thus, the RFID sensor will provide the same indication for the scenario illustrated in FIG. 5A in which the player placed the tomato inside the pan, and for the scenario illustrated in FIG. 5B in which the player placed the tomato out of the pan, directly on the stove. If the response to this reading was based only upon the reading obtained from the sensor, the response to the situation illustrated in FIG. 5B would not reflect accurately the situation in the play scene. The data obtained from the camera is necessary to correct the false reading in this situation in order to provide the player with a suitable response.

An opposite situation is illustrated in FIGS. 5C-5D. In these figures a pot 56 containing vegetables 57 is positioned on stove 50. When the pot is not covered the camera 10 of smart device 55 positioned on stand 551 captures the vegetables and image data of a pot with vegetables is transmitted to the smart device that outputs a relevant response to the player. However, the camera may have difficulty in detecting all the vegetables in the pot, since some of them may be partially hiding the others. Thus, the sensors placed inside the toy may provide a complementary data. Moreover, when the pot is covered by cover 561, the vegetables are invisible to the camera and a false reflection of the playing scene may be obtained. In this case, the RFID sensors provide complementary information as the vegetables are recognized by the RFID reader with and without the pan cover. Thus, the complementary input of the sensors is crucial for obtaining an accurate reflection of the playing scene and production of a relevant response to the reflected scene.

Another confusing playing scenario may occur while playing be a connected baby doll having accessories among which is a feeding bottle that the player may feed the doll. In this example, the doll mouth comprises a sensor configured to provide indication upon insertion of the feeding bottle into the doll mouth. The play pattern consists of instructing the user to feed a baby doll. Feeding the baby is carried out by placing a bottle in the baby's mouth. This indication is achieved by pressing a button that is inside the baby's mouth. The camera enables the system to verify that the bottle is the object that was used to press the button inside the baby's mouth and not another object such as a finger or a pencil, by also recognizing proximity between the aforementioned bottle and the baby's mouth. Both sensing methods are enabled and active at any time, and any event moves the system to another state, until reaching a success. Without these sensing methods, a false positive reading may occur if the player is not using the bottle that may consequent with none appropriate response with respect to the real occurrence.

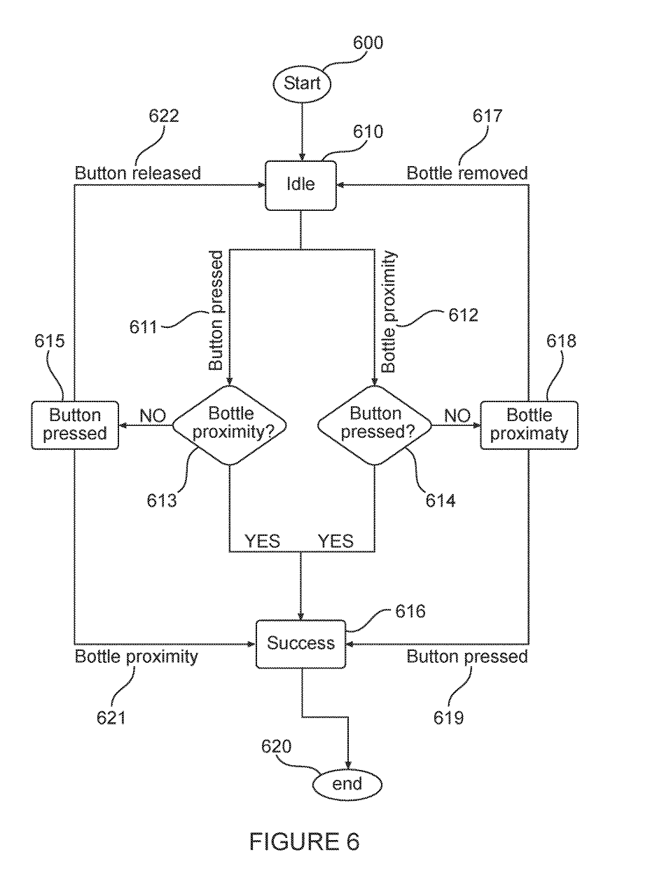

FIG. 6 is a state machine flow for the aforementioned example with the connected baby doll and the bottle, illustrating different states and the events that transit the machine from one state to another. From start point 600, the machine is directed to state 1 “Idle” (610) that instructs the player to “feed the baby”, i.e. to place the bottle inside the baby's mouth and waits for events. Upon recognition of bottle proximity by the camera (612), a decision 614 if “Button pressed?” is made in the state machine of whether a button in the doll mouth is already recognized to be pressed. If a button is also pressed (as well as bottle proximity was recognized), then go to state 4 “Success” (616) and to end point 620, else go to state 3 “Bottle proximity” (618) and wait for button pressed. From state 3 “Bottle proximity”, if the bottle is removed (617), go back to state 1 “Idle” (610), and if a button is pressed (619), go to state 4 “Success” (616) and to end point (620). From state 1 “Idle” (610), on the other hand, if an event of button press (611) is first recognized, decision (613) of “Bottle proximity” is made of whether a bottle is also recognized by the camera to be near the baby's mouth. If the bottle is near, then go to state 4 “Success” (616) and to end point 620, else go to state 2 “Button pressed” (615) and wait for bottle proximity recognition. From state 2 “Button pressed”, if the button is released (622), then go to state 1 “Idle” (610), and if a bottle proximity is recognized (621), then go to state 4 “Success” (616) and to end point (620). Upon reaching state 4 “Success” give feedback to the player from the app.

D. Identical Objects Differentiation

Since camera recognition is based on visible image, the algorithms cannot differentiate between two or more similar objects. The process can only output how many objects are recognized and where in space, but cannot specify different instances of the same object type.

This limitation is relevant to instances in which there are two toys or more in the scene with similar visual appearance. For example, in a scenario in which two children are playing with two connected toy swords, the swords may be in the same color or texture, and the camera may find it difficult to differentiate between them. The players may further change locations during the game, stand near or behind each other, and the camera may find it difficult to track them. In the world of connected toys, the toy may further have virtual attributes, such as game points, level achieved, powers and the like, and this information may be specific to a player's personal connected toy. Thus, a player may want to have his unique attributes available to him in the game with another player, and to use them during the game. When two toys or more are visually identical, this main feature of the connected toys becomes problematic. In accordance with one optional solution, each of the identical toys may have an output sensor, such as RGB LED or other lightning. Although the game is fully controlled or partially involves the camera identification of the objects in space, a first setting is made by the smart device, assigning each toy a different output signal in the beginning of the game, such as a different color or a different blink to each of the toys participating in the game. The toy may further include a unique toy ID, which is associated with a specific list of achievements in the game. In this embodiment, the toy may send its ID to the smart device that will retrieve its virtual attributes in the game, and will further indicate this toy's output element to signal. Once the output signal is recognized by the camera, the toy is identified in space and associated with its virtual attributes. The same process is made for the second toy, the third toy and so on. When all the connected toys in the play scene are identified, the game starts. In this specific example, the camera has a clear ability to identify a toy, and assign its virtual attributes according to its movements in space. The toy may further gain power and points during the game with the other players, which will be processed by the camera and assigned to the toy for the long term game experience.

Another example of such scenario involves a multiplayer game where two or more players hold connected dinosaur toys that are identical. The players stand before the camera and move their dinosaurs, each move their belonging object. The camera captures and recognizes the position of each dinosaur, and a LED lights hint about the assignments of each object. The application should receive, for example, an event about an object that is detected as a dinosaur with a red color (that belongs to player A) and another dinosaur with a blue color (that belongs to player B).

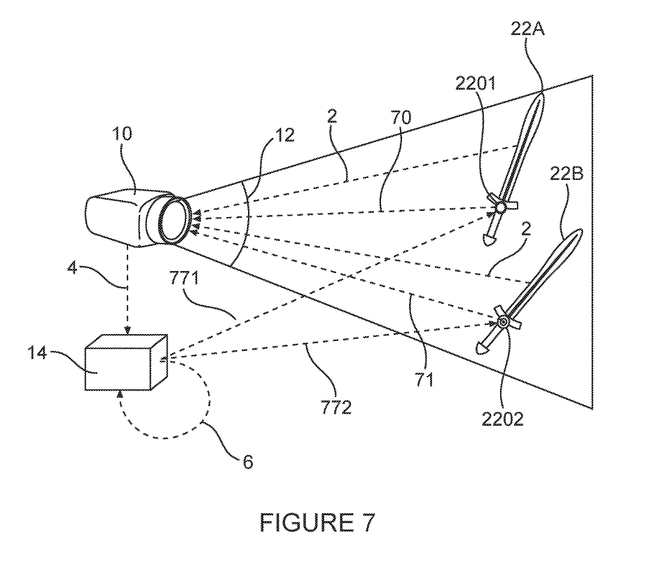

A schematic illustration of this limitation and the proposed solution are provided in FIG. 7. Camera 10 captures images 2 from similar connected toy swords 22A and 22B, both toys are within the field of vision 12 of camera 10. The images data 4 obtained by the camera is delivered to processing device 14 of the smart device that recognized that it is connected to two objects 22A and 22B.

A dedicated application in the smart device differentiates between the two similar objects and communicates with them however, although the application recognized multiple unique in-app entities (e.g. different players), and multiple toy identities, the camera recognizes similar objects. To avoid false reading of the playing scene, the processing device 14 (via the app) instructs 771 the first sword 22A to light a LED with unique color and brightness 2201, and further instructs 772 second sward 22B to light a LED with unique color, blinking pattern and/or brightness 2202. In the next step, the camera captures in addition to the images 2 of each of the toy swords the image 70, and 71 of the unique LED attached thereto. The processing device 14 processes the data 6 and then associates the toy identity of object 22A with visual image 2201, and toy identity of 22B with visual image 2202. In addition to the high level recognition obtained by this solution, the image data serves in this example to operate output elements positioned on the connected toy.

E. Lighting Condition Dependency

Cameras in general and image recognition algorithms particularly are majorly dependent and negatively affected by bad lighting conditions. Too much or too little light can reduce the quality of the recognition. To avoid such situations the surroundings lighting conditions may be nulled by addition of emphasizing LEDs on the connected toy. By attaching an LED light to the object that needs to be recognized/tracked, its appearance is emphasized with an actively and dynamic light marker that highlights it out compared to other objects in the image.

F. Accessory Recognition

When combining accessory objects that can be used with the main toy, it may become difficult to detect the presence of them and moreover their interaction with the main target object. One optional solution for that limitation is the addition of sensors to the accessory toys in order to improve their recognition as illustrated with reference to FIG. 5 with the connected stove toy.

Additional features like LEDs, buttons, buzzers and the like may be added to the toy, and can be controlled by the smart device. A flying dragon can be identified by the camera, and the flying movements may be identified by both motion sensors (accelerometer, gyro and the like) and a camera. A button placed on the dragon's back might shoot flames out of his mouth on the virtual world. Stroking the dragon's back may be detected by a piezoelectric sensor placed on the dragon's back, since the camera cannot identify movement on the toy's back. On contrary, stroking the front part of the dragon, which is within the site of the camera, may be captured by the camera and not by sensors. This will reduce the amount of sensors needed, and thus reduce battery consumption and electricity.

Another possible embodiment of the above invention is the use of mechanic parts, such as eyes and mouth movement's implementation in the toy and toys with moving abilities that comprises for example, wheels. In this embodiment, the smart device may activate the mechanical parts. In one implementation, which may be relevant to cases of multi-player social game, the camera may identify the mechanic movements of the second toy, creating a multi-player game without depending on the internet. For example, if two players play together in the same room, but each player has his own toy (for example, two connected toy cars are played together), and each controlled by another device (for example, car A is controlled by device A, and car B is controlled by device B). In this example, Device A will make car A move forward, thus will hold the information about the movement and timing of car A. Device B, which is not connected to smart device A directly, will pick up the movement of car A by its camera, and will make car B respond by moving backwards. This solution will enable two toys or more to communicate, without using wireless connection such as Wi-Fi, Bluetooth, BLE, and the like. It should be clear that this embodiment is not limited to mechanical parts, and may also be used with LEDs, buttons, sensors and the like. The above examples are not limited to a specific toy, and may further implemented into many different toys, such as, but not limited to, dolls, plush toys and pets, doll-houses, cars, action figures, trains, and toy-kitchen.

In accordance with variations of the invention, the camera used may be a 2D camera or a 3D camera.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A connected toy device comprising at least one sensing element configured to provide a complementary data to a limited visual recognition data obtained from a camera, so as to obtain an accurate reflection of a real-time playing scene of a player with said connected toy device and allow production of a suitable response to the player on a smart device connected to said toy according to processing of the combined data obtained from said camera and the at least one sensing element.

2. A connected toy device according to claim 1, wherein said sensing element is configured to provide a complementary data about the real-time playing scene for hidden objects and/or actions made by the player that are not captured by said camera upon usage of said toy device.

3. A connected toy device according to claim 1, wherein said sensing element is configured to provide a complementary data about the real-time playing scene for objects that are positioned outside the field of vision of said camera upon usage of said toy device.

4. A connected toy device according to claim 1, wherein said sensing element is configured to provide a complementary data about the real-time playing scene for at least one movable object that its distance from said camera changes upon usage of said toy device.

5. A connected toy device according to claim 1, wherein said sensing element is configured to provide a complementary data about the real-time playing scene for at least two identical objects that are being played with simultaneously so as to allow the camera ability to distinguish between them.

6. A connected toy device according to claim 1, wherein said sensing element is configured to provide a complementary data about the real-time playing scene when the player apply force and/or touch said toy device and parts thereof.

7. A connected toy device according to claim 1, wherein said sensing element is selected from the group consisting of: RFID, NFC, capacitive sensors, hotspots, ultrasonic triangulation based sensors, sensors based on energy harvesting, weight sensors, photo-sensors, color sensors, gated buttons and a camera.

8. A connected toy device according to claim 1, wherein said toy device further comprises input and/or output elements.

9. A connected toy device according to claim 1, wherein said visual recognition data is obtained from a camera of a smart device and wherein said complementary data obtained by said at least one sensing element is transmitted and analyzed by said smart device to thereby allow processing of the combined data.

10. A connected toy device according to claim 1, further comprising an output element, wherein said output element is activated by data obtained from said camera in response to environmental conditions in the real-time playing scene.

11. A connected toy device according to claim 10, wherein said output element is a light being turned on/off according to inadequate lighting condition that limits accurate image recognition of the real-time playing scene by said camera.

12. A connected toy device according to claim 1, wherein said at least one sensing element is an identification sensor configured to provide a complementary data for identifying the relations between objects in space of the playing scene in real-time.

13. A connected toy system comprising a connected toy device according to claim 1 and a smart device having a dedicated software library configured to allow processing of image data obtained by a camera of said smart device together with data received from said toy device, and producing a suitable response on a smart device reflecting a real time occurrence at the playing scene.

14. A connected toy system according to claim 13, wherein said response is produced on the connected toy device.

15. A connected toy system for obtaining an accurate reflection of a real-time playing scene of a player with a connected toy device, said system comprising:
a. at least one connected toy devise having at least one sensing element configured to provide a complementary data to a limited visual recognition data obtained from a camera; and
b. a smart device having at least a camera, a processing device and a dedicated software library, said smart device is configured to capture images of said playing scene by said camera process the data and combine the image data with data received from said at least one sensing element, and produce a suitable response to said player according to the combined data obtained from said camera and said at least one sensing element reflecting a real time occurrence at the playing scene.

16. A connected toy system according to claim 15, wherein said camera is an independent camera configured to submit the image data captured at the playing scene to a smart device.

17. A method for obtaining an accurate reflection of a real-time playing scene of a player with a connected toy device, said method comprising the following steps:
a. Obtaining data from at least one connected toy devise having at least one sensing element configured to provide a complementary data to a limited visual recognition data obtained from a camera and transmitting the obtained data to a smart device;
b. Obtaining data from a camera configured to capture images in real-time of said playing scene and transmitting the data to said smart device;
c. Processing the data obtained from said camera and said connected toy device by the smart device said, smart device having a dedicated software library, configured to combine the image data with data received from said at least one sensing element of the toy and to process the data; and
d. Producing a suitable response according to the processed data, said response is reflecting a real time occurrence at the playing scene.

18. A connected toy system according to claim 13 wherein said connected toy device further comprises at least one input and/or output element.

19. A connected toy system according to claim 13 wherein the visual recognition data of said connected toy device is obtained from a camera of said smart device and wherein said complementary data is obtained by at least one sensing element and is transmitted and analyzed by said smart device to thereby allow processing of the combined data.

20. A connected toy system according to claim 13 wherein said connected toy device further comprises at least one output element, wherein said output element is activated by data obtained from said camera in response to environmental conditions in the real-time playing scene.
